(19) United States
(12) Patent Application Publication
(10) Pub. No.: US 2013/0249667 A1
(43) Pub. Date: Sep. 26, 2013

(54) Communication System and Method

(71) Applicant: Simon Brohez, Namur (BE)

(72) Inventor: Simon Brohez, Namur (BE)

(21) Appl. No.: 13/425,904

(22) Filed: Mar. 21, 2012

(51) Int. Cl. G06F 13/42

(52) U.S. Cl. 340/1.1

(57) ABSTRACT

A device is provided that includes a network communication portion, a device communication portion, a registration portion and a controller. The network communication portion can communicate with a communication network. The device communication portion can communicate with a first communication device, can communicate with a second communication device, can receive a registration communication, can receive a first communication and can receive a second communication. The registration portion can associate the second communication device with the first communication device based on the registration communication. The controller portion can instruct the device communication portion to transmit the first communication to the first communication device and to transmit the second communication to the first communication device.

The present application claims priority from U.S. Provisional Application No. 61/466,422 filed Mar. 22, 2011, and U.S. Provisional Application No. 61/466,429 filed Mar. 22, 2011, the entire disclosures of which are incorporated herein by reference.

### BACKGROUND

The present invention relates to communication systems.

Currently, there ways to simultaneously contact many people from a single communication device. Consider the situation where one person, Bob, wants to speak with a plurality of his friends. First, Bob might have his communication device preprogrammed to talk (voice) or send text (data) to a plurality of devices, each corresponding to a plurality of people within in a predetermined group. Further, Bob may have many different communication devices, with this feature, including a land line, a cell phone, a computer and wireless tablet.

In the conventional communication system discussed above, if any of Bob's friends want to contact Bob, they must contact him via Bob's land line, his cell phone, his computer or his wireless tablet.

A conventional communication system has been developed to streamline communication between people, who may have many contacts. This type of system uses a dedicated portal for each person, and will now be described in greater detail with reference to FIG. 1.

FIG. 1 illustrates a conventional communication system.

As shown in the figure, communication system 100 includes a communication network 102. A plurality of users, a sample of which is indicated as users 110, 112 and 114 connect to communication system 102 via a plurality of portals, a sample of which is indicated here as portals 104, 106 and 108.

Communication system 100 includes public switch telephone network (PSTN) 116, satellite network 118, Internet 120 and cellular network 122.

User 110 includes devices 124 and 126. User 112 includes devices 128, 130 and 132. User 114 includes devices 134 and 136.

PSTN 116 is able to bidirectionally communicate with cellular network 122, satellite network 118 and internet 120. Internet 120 is able to bidirectionally communicate with satellite network 118 and cellular network 122. Cellular network 122 is able to bidirectionally communicate with satellite network 118. Each of PSTN 116, cellular network 122, satellite network 118 and internet 120 is able to communicate with portals 104, 106 and 108. So for purposes of explanation and brevity, portals 104, 106 and 108 are able to communicate with communication system 102 by communicating with any of the networks within it.

Portals 104, 106, and 108 can bidirectionally communicate with users 110, 112, and 114, respectively, and with communication network 102.

PSTN 116 includes telephone lines, fiber optic cables, microwave transmission links and undersea telephone cables, all interconnected by, switching centers, thus allowing any telephone in the world to communicate with any other.

Satellite network 118 is a system of satellites either fixed in space (geosynchronous satellites) or in orbit around the earth at low altitudes (low earth orbit satellites).

Internet 120 is a global system of interconnected computer networks, consisting of millions of private, public, academic, business and government networks connected by a broad array of electronic, wireless and optical networking technologies.

Cellular network 122 is a radio network distributed over land areas called cells, and when joined together these cells provide radio coverage over a wide geographic area. This enables a large number of portable devices (mobile phones, pagers, etc.) to communicate with each other and with fixed devices and telephones anywhere in the network.

Portals 104, 106 and 108 serve as gateways to provide users 110, 112 and 114 access to communication network 102. Users 110, 112 and 114 must first connect with portals 104, 106 and 108 in order to be routed to one of the networks within communication network 102.

In order to connect with portals 104, 106, and 108, users 110, 112, and 114 must utilize devices 124-136. Devices 124-136 may include land-line telephones, cellular telephones, satellite telephones, pagers, computers, or other devices that can be used to secure a connection with portals 104, 106, and 108 in order to access networks 116-122 of communication network 102.

Consider the situation where one person, Bob, wants to speak with another person, Joe. With communication system 100, Bob would merely need to contact the portal associated with Joe. For example, consider that Bob is user 114, whereas Joe is user 110.

In operation, user 110 may want to use device 126 (in this case, a cellular phone) to contact device 134 (in this case, a land-line phone) of user 114. User 110 would use device 126 to connect with portal 104, which would then connect with cellular network 122 of communication network 102. The call would then be routed from cellular network 122 to PSTN 116, then from PSTN 116 to portal 108. From portal 108, the call would then be routed to device 136 of user 114 to complete the connection.

In some prior art systems, portals 104, 106, and 108 include a unique identifier that must be known in order to make a connection through portals 104, 106, and 108. For example, the unique identifier may be a telephone number. In operation of these systems, in order for user 110 to use device 126 to contact device 134 of user 114, user 110 must know the unique identifier associated with portal 108 in order to contact user 114. Therefore, in addition to knowing the telephone number of device 134, in order to contact user 114 it is also required to know the contact number of portal 108, and first make a connection with portal 108 before connecting with user 134.

In another conventional communication system, calls may be forwarded to another device. This type of “call forwarding” is “context-less”: whatever the context, a call is forwarded from A to B. This may not be useful when an incoming communication is text, or video data.

What is needed is a system and method for providing a single portal through which communications are routed, thus simplifying the connection process described above.

### BRIEF SUMMARY

The present invention provides is a system and method for providing a single portal through which communications are routed.

In accordance with an aspect of the present invention, a device is provided for use with a first communication device of a first user, a second communication device of a first user, a third communication device of a second user, a fourth communication device of a third user, a communication network and a registration communication. The third communication device can transmit a first communication to the second communication device by way of the communication network. The fourth communication device can transmit a second communication to the second communication device by way of the communication network. The second communication device can receive the first communication from the communication network. The second communication device can receive the second communication from the communication network. The registration communication is based on the first communication device. The second communication device can further transmit the first communication and can transmit the second communication. The device includes a network communication portion, a device communication portion, a registration portion and a controller. The network communication portion can communicate with the communication network. The device communication portion can communicate with the first communication device, can communicate with the second communication device, can receive the registration communication, can receive the first communication and can receive the second communication. The registration portion can associate the second communication device with the first communication device based on the registration communication. The controller portion can instruct the device communication portion to transmit the first communication to the first communication device and to transmit the second communication to the first communication device.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a conventional communication system;

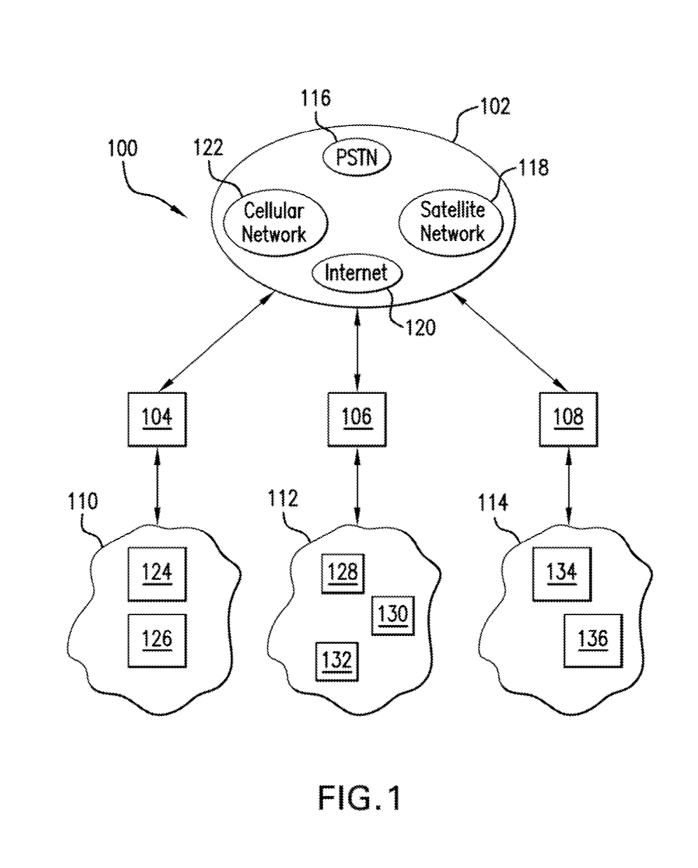

FIG. 2 illustrates a communication system in accordance with aspects of the present invention;

FIG. 3 illustrates an exploded view of an example centralized communication management system (CCMS) of FIG. 2;

FIG. 4 illustrates a user that communicates via the CCMS of FIG. 3;

FIG. 5 illustrates a plurality of users organized into groups based on the preferences of the user of FIG. 4;

FIG. 6 illustrates an attempt to open multiple connections between the user of FIG. 4 and one of the groups of FIG. 5;

FIG. 7 illustrates a process by which the CCMS of FIG. 3 determines how to rout an attempt to open the connection of FIG. 6;

FIG. 8 illustrates an attempt to open multiple connections between the user of FIG. 4 and more than one of the groups of FIG. 5;

### DETAILED DESCRIPTION

The present invention is drawn to a centralized communication management system that provides a single repository of user information. Users input registration information, contact information, contact preferences, address books, availability information and any other information deemed useful to the user. Any communications sent to, or received from, users registered on the system will be routed through the centralized communication system, and decisions regarding how the communication is routed will be made based on the information provided to the system by the user.

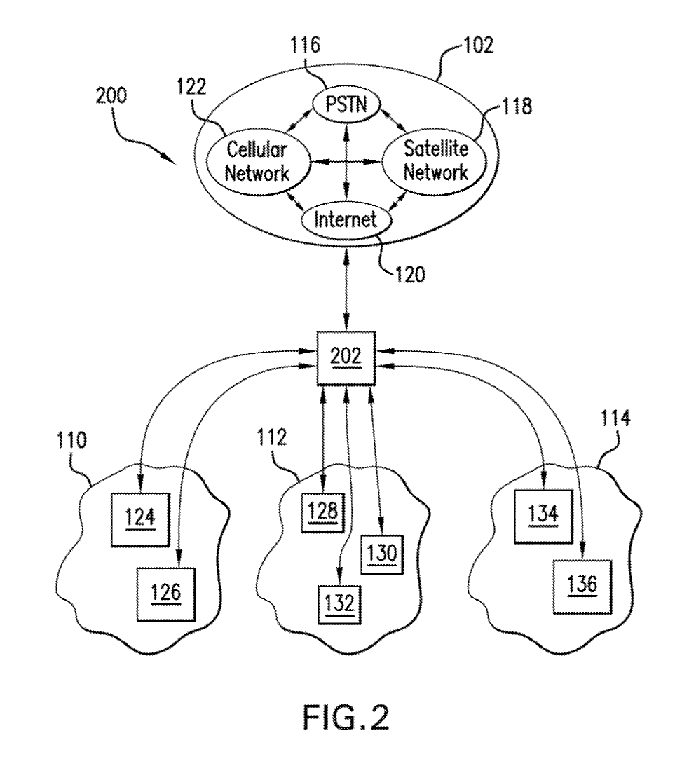

Aspects of the present invention as discussed above will now be further described in greater detail with reference to FIGS. 2-7.

FIG. 2 illustrates a communication system 200 in accordance with aspects of the present invention.

As shown in the figure, communication system 200 includes communication network 102, centralized communication management system (CCMS) 202 and a plurality of users, a sample of which is indicated here as users 110, 112, and 114.

CCMS 202 is arranged to communicate with each of users 110, 112, and 114 and with communication network 102.

CCMS 202 serves as a gateway to provide users 110, 112 and 114 access to communication network 102. Users 110, 112 and 114 must first connect with CCMS 202 in order to be routed to one of the networks within communication network 102.

In operation, user 110 may want to use device 126 (in this case, a cellular phone) to contact device 134 (in this case, a land-line phone) of user 114. User 110 would use device 126 to connect with CCMS 202, which would then connect with cellular network 122 of communication network 102. The call would then be routed from cellular network 122 to PSTN 116, then from PSTN 116 back to CCMS 202. From CCMS 202, the call would then be routed to device 136 of user 114 to complete the connection.

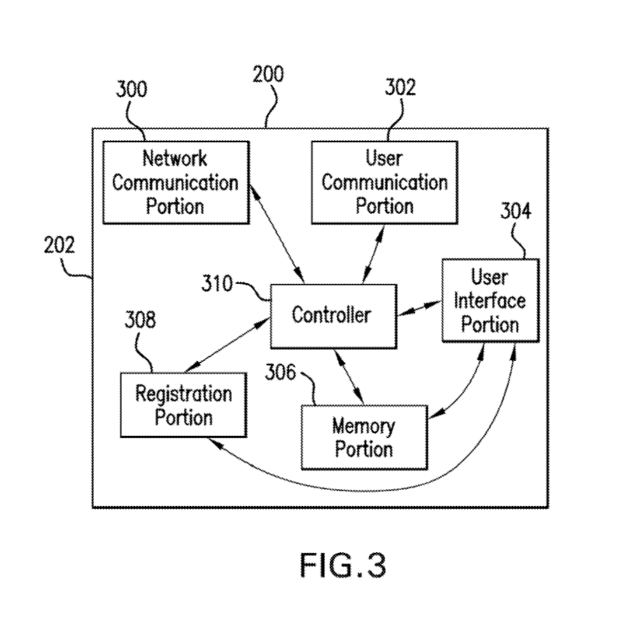

FIG. 3 illustrates an exploded view of an example CCMS 202 of FIG. 2.

As shown in FIG. 3, CCMS 202 includes a controller portion 310, a network communication portion 300, a device communication portion 302, a user interface portion 304, a memory portion 306 and a registration portion 308.

Controller 310 is operable to bidirectionally communicate with network communication portion 300, device communication portion 302, user interface portion 304, memory portion 306 and registration portion 308. User interface portion 304 is operable to bidirectionally communicate with memory 306 and registration portion 308.

Controller 310 controls interactions between the individual portions of CCMS 202. Controller 310 analyzes information provided to it by network communication portion 300, device communication portion 302, user interface portion 304, memory portion 306 and registration portion 308 and determines actions that should be taken based on the available information.

Network communication portion 300 is operable to bidirectionally communicate with communication network 102 and provide controller 310 information regarding communications with communication network 102.

Device communication portion 302 is operable to bidirectionally communicate with users 110, 112 and 114 and provide controller 310 information regarding communications with users 110, 112 and 114.

User interface portion 304 is operable to bidirectionally communicate with users 110, 112 and 114. Users 110, 112 and 114 input information regarding their profiles to user interface portion 304, and user interface portion 304 may provide feedback to users 110, 112 and 114 regarding the information. Information may include the addition of user contacts, grouping of the user contacts into specific groups, availability of the user to receive calls from the user contacts, or any other information that may be useful in streamlining the communication process for the user. Users 110, 112 and 114 can input information into user interface portion 304 via mobile phone, satellite phone, the Internet, or other mediums that allow for information to be exchanged.

Memory portion 306 is operable to save information provided to user interface portion 304, and provide controller 310 access to the information. In essence, a user may be able to interface with controller 310 by way of user interface portion 304.

Registration portion 308 is operable to receive information provided to user interface portion 304 and complete a registration process. During the registration process, the user will upload information to user interface portion 308 using a mobile device or computer. Registration information generated during the registration process is accessible to controller 310. This upload may be considered a registration communication.

For example, registration portion 308 may include a lookup table that includes numerous data portions. One data portion, for example, may include a user ID and password that is chosen by the user during the registration process. The user ID is a unique identifier that can be assigned to only one user, and is used by the user to update or modify information entered during the registration process.

A second data portion may include all the contact information the user would like to associate with the chosen user ID. For example, the user may register home, office and mobile phone numbers, personal and work e-mail addresses, and any other manner by which the user could be contacted.

A third data portion may include preferences for access to the telephone numbers. For example, if the user registers three telephone numbers, access to telephone number 1 may be limited to family members, access to telephone number 2 may be limited to friends, and access to telephone number 3 may be limited to co-workers.

A fourth data portion may include preferences for what action to take if the user is not available or does not answer a phone call. Preferences may include forwarding a phone call to a different number, forwarding a phone call to a voice mail system, or automatically sending a text message as a notification that the user is currently unavailable.

A fifth data portion may include the daily calendar of the user. Access to the calendar is provided to registration portion 308 by the user, and the calendar may be synced with registration portion 308 as specified by the user.

A sixth data portion may include the communication route based on the context of a call. For example, depending on the caller, the user's location, the user's availability, the time, or even based on information of urgency that could be given by the caller, the user may be able to input a specific “route” which will be the best way to be reached. For example, the user may indicate that all voice calls are forwarded to a cell phone, whereas all image and video data are forwarded to the user's portable tablet device.

The data portions discussed above are non-limiting examples, and in use the types of information that can be input by the user during the registration process may include other data portions.

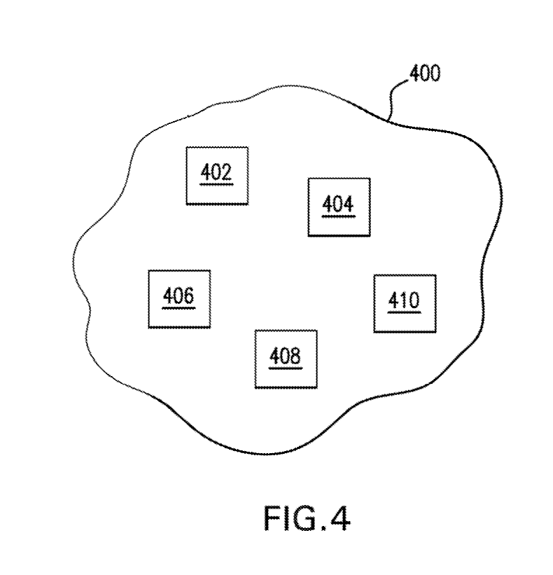

FIG. 4 illustrates user 400 that communicates via CCMS 202 of FIG. 2.

As shown in FIG. 4, user 400 possesses a plurality of connection devices 402-410 that can be used to access communication networks 100 of FIG. 2.

Devices 402-410 may include land-line telephones, cellular telephones, satellite telephones, pagers, computers, or other devices that can be used for communication. User 400 may add, change or delete communication devices from the user profile by communicating the changes to CCMS 202.

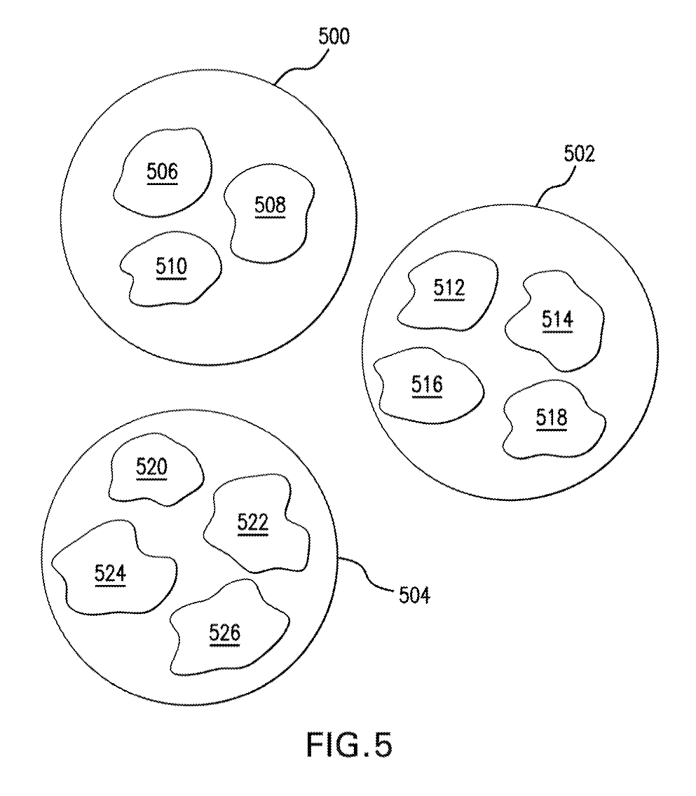

FIG. 5 illustrates a plurality of users 506-526 organized into groups 500-504 based on the preferences of user 400 of FIG. 4.

As shown in FIG. 5, group 500 includes users 506, 508 and 510. Group 502 includes users 512, 514, 516 and 518. Group 504 includes users 520, 522, 524 and 526.

Returning to FIG. 3, user 400 can organize and reorganize groups. Group choices of user 400 are entered into CCMS 202 via user interface portion 304, and those choices are routed through controller 310 to memory portion 306.

Returning to FIG. 5, how groups are organized is left to the discretion of the user. For purposes of illustration, group 500 may be family members of user 400, group 502 may be coworkers of user 400 and group 504 may be friends of user 400.

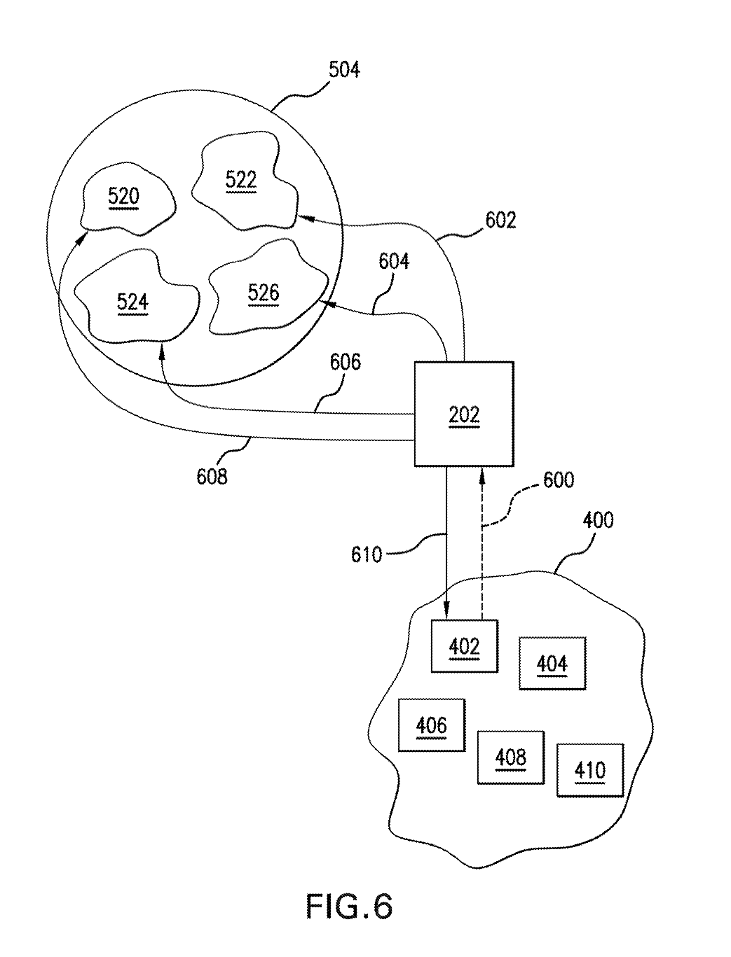

FIG. 6 illustrates an attempt to open multiple connections between user 400 of FIG. and one of groups 500-504 of FIG. 5.

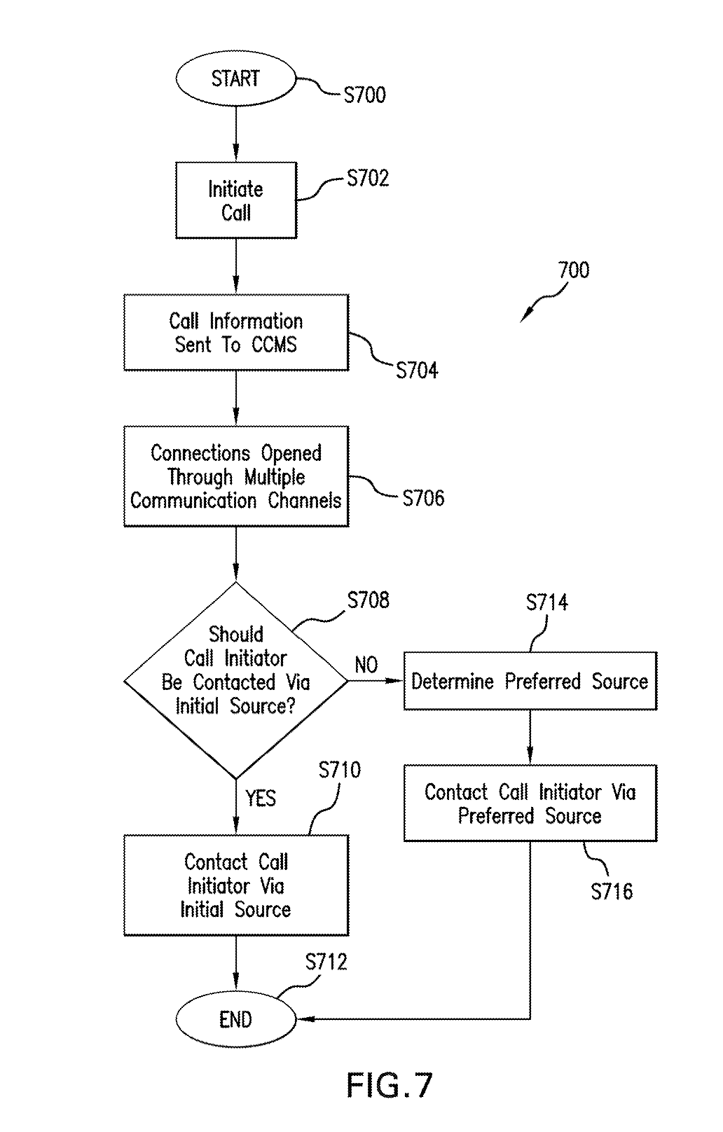

As shown in FIG. 6, user 400 attempts to call group 504 via device 402. Device 402 routs the attempted call information through CCMS 202 via communication channel 600. CCMS 202 attempts to contact users 520-526 of group 504 via communication channels 602-608. If connections are made with at least one of users 520-526, CCMS 202 will then contact device 402 of user 400 via communication channel 610 to complete the connection between user 400 and group 504. In an example scenario, the call initiated by user 400 is routed to each of users 520-526, and user 520 answers the call first. CCMS 202 then contacts device 402 of user 400 via communication channel 610, and user 400 answers the call. User 520 is now speaking with user 400. Users 522 and 524 also answer the call and join users 520 and 400 on the call already in progress. User 526 does not answer the call, and eventually CCMS 202 stops attempting to connect with user 526 and closes communication channel 604. User 520 may need to hang up earlier than other users, which will not impact the connection between users 522, 524, and 400. However, if user 400 hangs up, all other callers will be disconnected as well, because user 400 initiated the call. This process will be further described with reference to FIG. 7.

If CCMS 202 is unsuccessful in making a connection with at least one of users 920-926, CCMS 202 will notify user 400 via a voice message, text message, email or any other communication method preferred by user 400.

FIG. 7 illustrates a process 700 by which the CCMS 202 of FIG. 3 determines how to rout an attempt to open the connection of FIG. 6.

Returning to FIG. 6, process 700 starts (S700) and user 400 initiates a call to users 520-526 of group 504 (S702) that originates from device 402 via communication channel 600. The call may originate from a land line, mobile phone, satellite phone or other communication device.

It can also be appreciated that the attempt to connect to user 400 may not require a phone. Connection attempts may be made via email or other connection method, but for purposes of brevity the process will be described as a phone call. The same process would apply if an alternative connection method were employed.

Returning to FIG. 6, communication channel 600 sends the call information to CCMS 202 (S704).

Returning to FIG. 3, call information is received by device communication portion 302 of CCMS 202. Device communication portion 302 then sends the call information to controller 310.

Returning to FIG. 6, CCMS 202 then opens connections with one or more of users 520-526 of group 504 via communication channels 602-608 (S706).

CCMS 202 then must determine the preferred device for user 400 to communicate with users 520-526 of group 504 (S708).

Returning to FIG. 3, controller 310 forwards the call information to memory portion 306. Memory portion 306 evaluates the preferences of user 400 that were entered via user interface portion 304 and stored in memory portion 306 to determine the preferred device for user 400 to communicate with users 520-526 of group 504.

If memory portion 306 determines that device 402 is the preferred device, memory 306 forwards that information to controller 310. Controller 310 then instructs device communication portion 302 to connect to user 400 via device 402 (S710) and process 800 ends (S712).

If memory portion 306 determines that device 402 is not the preferred device, memory 306 determines the preferred source device (S714) and forwards that information to controller 310. In this example, the preferred source for a call to user 500 that is initiated by user 400 is device 402. Controller 310 then instructs device communication portion 302 to connect to user 400 via device 402.

Returning to FIG. 7, the call is routed through device 402 (S716) via communication channel 610, and process 700 ends (S712).

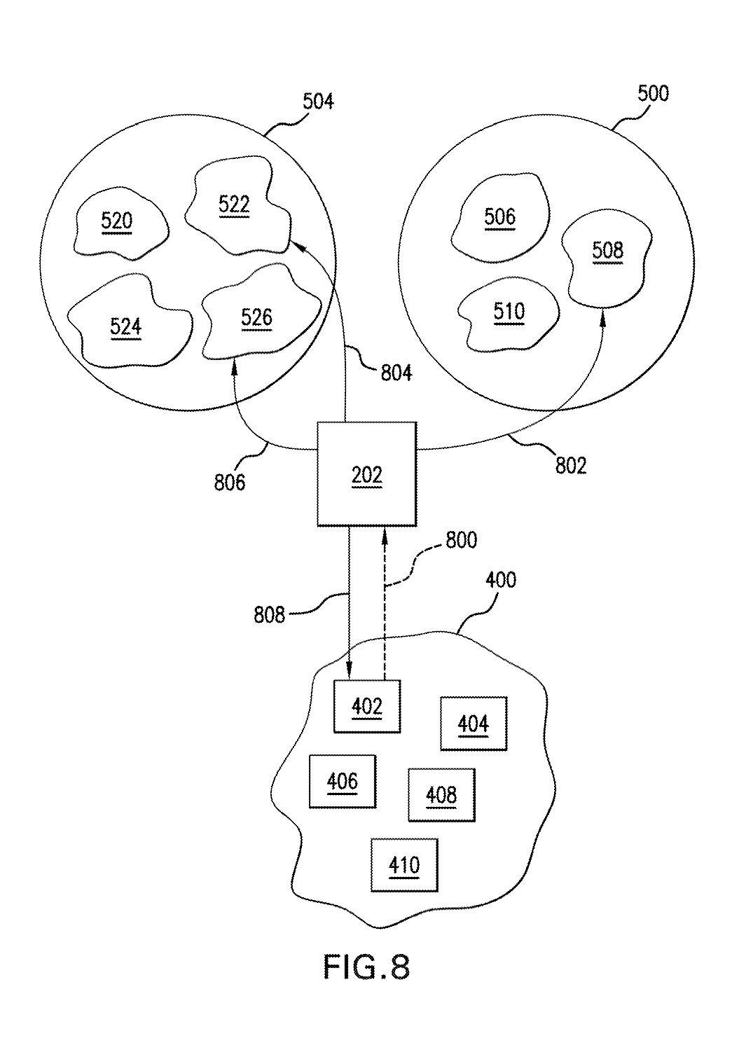

FIG. 8 illustrates an attempt to open multiple connections between user 400 of FIG. 4 and more than one of groups 500-504 of FIG. 5.

As shown in FIG. 8, user 400 initiates a request to open multiple connections with users 522 and 526 of group 504 and user 508 of group 500 via device 402. The request is forwarded to CCMS 202 via communication channel 800. In a manner similar to those previously described in FIG. 6 and FIG. 7, CCMS 202 will determine if device 402 is the device through which the connections should be established. If the preferred device is not device 402, CCMS 202 will rout the communication through the preferred device. In this example, the preferred device is device 402.

CCMS 202 attempts to contact users 508, 522 and 526 via communication channels 802, 804, and 806, respectively. If connections are made with at least one of users 508, 522 or 526, CCMS 202 will then contact user 400 via communication channel 808 to complete the connection between user 400 and at least one of users 508, 522 and 526. In an example scenario, the call initiated by user 400 is routed to each of users 508, 522 and 526, and user 522 answers the call first. CCMS 202 then contacts device 402 of user 400 via communication channel 610, and user 400 answers the call. User 522 is now speaking with user 400. User 508 also answers the call and joins users 522 and 400 on the call already in progress. User 526 does not answer the call, and eventually CCMS 202 stops attempting to connect with user 526 and closes communication channel 604. User 522 may need to hang up earlier than other users, which will not impact the connection between users 508 and 400. However, if user 400 hangs up, all other callers will be disconnected as well, because user 400 initiated the call.

If CCMS 202 is unsuccessful in making a connection with at least one of users 508, 522 or 526, CCMS 202 will notify user 400 via a voice message, text message, email or any other communication method preferred by user 400.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a first communication device of a first user, a second communication device of a first user, a third communication device of a second user, a fourth communication device of a third user, a communication network and a registration communication, the third communication device being operable to transmit a first communication to the second communication device by way of the communication network, the fourth communication device being operable to transmit a second communication to the second communication device by way of the communication network, the second communication device being operable to receive the first communication from the communication network, the second communication device being operable to receive the second communication from the communication network, the registration communication being based on the first communication device, the second communication device being further operable to transmit the first communication and to transmit the second communication, said device comprising:
a network communication portion operable to communicate with the communication network;
a device communication portion operable to communicate with the first communication device, to communicate with the second communication device, to receive the registration communication, to receive the first communication and to receive the second communication;
a registration portion operable to associate the second communication device with the first communication device based on the registration communication; and
a controller portion operable to instruct said device communication portion to transmit the first communication to the first communication device and to transmit the second communication to the first communication device.

2. The device of claim 1, further comprising a user interface portion operable to enable the second user to interface with said controller portion.

3. A method of using a first communication device of a first user, a second communication device of a first user, a third communication device of a second user, a fourth communication device of a third user, a communication network and a registration communication, the third communication device being operable to transmit a first communication to the second communication device by way of the communication network, the fourth communication device being operable to transmit a second communication to the second communication device by way of the communication network, the second communication device being operable to receive the first communication from the communication network, the second communication device being operable to receive the second communication from the communication network, the registration communication being based on the first communication device, the second communication device being further operable to transmit the first communication and to transmit the second communication, said method comprising:
communicating, via a device communication portion, with the first communication device to receive the registration communication;
associating, via a registration portion, the second communication device with the first communication device based on the registration communication;
receiving, via the device communication portion, the first communication and the second communication; and
instructing, via a controller portion, the device communication portion to transmit the first communication and the second communication to the first communication device.

4. The method of claim 3, further comprising enabling, via a user interface portion, the first user to interface with the controller portion.

5. A non-transitory, tangible, computer-readable media having computer-readable instructions stored thereon, the computer-readable instructions being capable of being read by a computer to be used with a first communication device of a first user, a second communication device of a first user, a third communication device of a second user, a fourth communication device of a third user, a communication network and a registration communication, the third communication device being operable to transmit a first communication to the second communication device by way of the communication network, the fourth communication device being operable to transmit a second communication to the second communication device by way of the communication network, the second communication device being operable to receive the first communication from the communication network, the second communication device being operable to receive the second communication from the communication network, the registration communication being based on the first communication device, the second communication device being further operable to transmit the first communication and to transmit the second communication, the computer-readable instructions being capable of instructing the computer to perform the method comprising:
communicating, via a device communication portion, with the first communication device to receive the registration communication;
associating, via a registration portion, the second communication device with the first communication device based on the registration communication;
receiving, via the device communication portion, the first communication and the second communication; and
instructing, via a controller portion, the device communication portion to transmit the first communication and the second communication to the first communication device.

6. The non-transitory, tangible, computer-readable media of claim 1, the computer-readable instructions being capable of instructing the computer to perform said method further comprising enabling, via a user interface portion, the first user to interface with the controller portion.
